(19) United States
(12) Patent Application Publication
(10) Pub. No.: US 2016/0040516 A1
(43) Pub. Date: Feb. 11, 2016

(54) HOUSING ASSEMBLIES FOR MOUNTING FLOW CONTROL DEVICES

(71) Applicant: Halliburton Energy Services, Inc., Houston, TX (US)

(72) Inventor: William Mark Richards, Flower Mound, TX (US)

(73) Assignee: Halliburton Energy Services, Inc., Houston, TX (US)

(21) Appl. No.: 14/396,310

(22) PCT Filed: Dec. 31, 2013
(86) PCT No.: PCT/US2013/078458

§ 371 Date: Oct. 22, 2014

(51) Int. Cl. E21B 43/08; B29C 65/02; B29C 65/48; C09J 163/00

(52) U.S. Cl. CPC E21B 43/086; C09J 163/00; B29C 65/02; B29C 65/48; B29L 2023/22

(57) ABSTRACT

A housing assembly, comprising: an outer form arranged about a base pipe, the base pipe including at least one flow port; an inner form arranged about the base pipe and nested within the outer form, thereby defining a sealed compartment between the outer and inner forms; and a composite resinous material disposable within the sealed compartment and curable to form a rigid housing arranged at or near the at least one flow port and in fluid communication therewith.

### BACKGROUND

The present disclosure generally relates to wellbore flow control devices, and more specifically, to housing assemblies for mounting flow control devices onto a base pipe.

In hydrocarbon production wells, it is often beneficial to regulate the flow of formation fluids from a subterranean formation into a wellbore penetrating the same. A variety of reasons or purposes can necessitate such regulation including, for example, preventing of water and/or gas coning, minimizing of water and/or gas production, minimizing of sand production, minimizing of oil production, balancing production from various subterranean zones, equalizing pressure among various subterranean zones, and/or the like.

A number of devices are available for regulating the flow of formation fluids. Some of these devices are non-discriminating for different types of formation fluids and can simply function as a “gatekeeper” for regulating access to the interior of a wellbore pipe, such as a well string. Such gatekeeper devices can be nozzles, flow orifices, on/off valves, or they can be metered to regulate fluid flow over a continuum of flow rates. Other types of devices for regulating the flow of formation fluids can achieve at least some degree of discrimination between different types of formation fluids. Such devices can include, for example, non-autonomous inflow control devices and autonomous inflow control devices, collectively referred to herein as “flow control devices.”

Flow control devices may be mounted along a base pipe (e.g., production tubing) to control the flow of fluid between the exterior and interior of the base pipe. As used herein, the term “fluid” refers to gas phase and liquid phase substances. Fluid may come into contact with the fluid control device via an opening or a screen, and the fluid control device may be configured such that they provide a greater resistance to the flow of undesired fluids (e.g., water and/or gas) than they do to desired fluids (e.g., oil), particularly as the percentage of the undesired fluids increases. Autonomous flow control devices may perform the functions without the need for operator control.

Flow control devices are often mounted in housings that are welded to the base pipe. Such welding operations may be very time-consuming and require the application of substantial heat, which may translate into considerable cost and exposure of welding operators to hazardous conditions. Moreover, welds are often prone to crack formations upon being exposed to extreme downhole environments, thereby requiring additional care and expertise by a welding operator to place highly accurate and complete welds. Welding material is also often specific to the type of base pipe and flow control device housing assembly material utilized, thereby restricting the types of such materials that may be utilized.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 illustrates a well system that can exemplify the principles of the present disclosure, according to one or more embodiments described herein.

FIGS. 2A-2B illustrate enlarged cross-sectional views of an exemplary housing assembly comprising an inflow control device, according to one or more embodiments described herein.

FIGS. 3A-3B illustrate enlarged cross-sectional views of an exemplary housing assembly comprising an autonomous inflow control device, according to one or more embodiments described herein.

FIG. 4A-B illustrate enlarged cross-sectional views of an exemplary housing assembly comprising a nozzle flow control device, according to one or more embodiments described herein.

FIG. 5A-C illustrate enlarged axial cross-sectional views of an exemplary housing assembly, according to one or more embodiments described herein.

FIG. 6 illustrates an enlarged front view and incorporated cross-sectional view of an exemplary housing assembly comprising multiple flow control devices, according to one or more embodiments described herein.

FIG. 7 illustrates an enlarged axial cross-sectional view of an exemplary housing assembly, according to one or more embodiments described herein.

FIG. 8 illustrates an enlarged axial cross-sectional view of an exemplary housing assembly, according to one or more embodiments described herein.

### DETAILED DESCRIPTION

The present disclosure generally relates to wellbore flow control devices, and more specifically, to housing assemblies for mounting flow control devices onto a base pipe.

Disclosed are various embodiments of a mounted flow control device. The flow control device may be a non-autonomous flow control device or an autonomous flow control device and may be mounted onto a base pipe using pre-formed molds and a composite resinous material. The embodiments herein allow flow control devices to be mounted or otherwise installed without the use of welding operations and, thus, may reduce the time and labor required to install such flow control devices. The embodiments herein may have a positive economic impact on production, efficiency, and safety. Additionally, the embodiments described herein allow an operator to provide whatever contours of shape or configuration of the housing assemblies described herein by simply designing an appropriate mold.

One or more illustrative embodiments disclosed herein are presented below. Not all features of an actual implementation are described or shown in this application for the sake of clarity. It is understood that in the development of an actual implementation incorporating the embodiments disclosed herein, numerous implementation-specific decisions must be made to achieve the developer's goals, such as compliance with system-related, lithology-related, business-related, government-related, and other constraints, which vary by implementation and from time to time. While a developer's efforts might be complex and time-consuming, such efforts would be, nevertheless, a routine undertaking for those of ordinary skill the art having benefit of this disclosure.

It should be noted that when “about” is provided herein at the beginning of a numerical list, the term modifies each number of the numerical list. In some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the exemplary embodiments described herein. At the very least, and not as an attempt to limit the application of the doctrine of equivalents to the scope of the claim, each numerical parameter should at least be construed in light of the number of reported significant digits and by applying ordinary rounding techniques.

While compositions and methods are described herein in terms of “comprising” various components or steps, the compositions and methods can also “consist essentially of” or “consist of” the various components and steps. When “comprising” is used in a claim, it is open-ended. When “comprising” is used in the disclosure, it is open-ended.

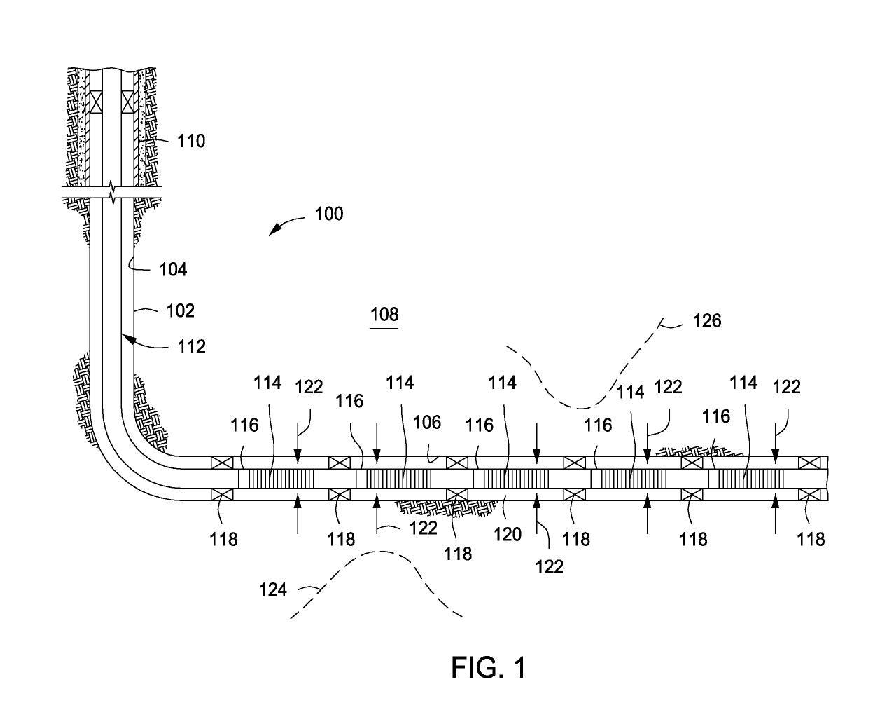

Referring to FIG. 1, illustrated is a well system 100 that exemplifies principles of the present disclosure, according to one or more embodiments. As illustrated, well system 100 may include a wellbore 102 that has a generally vertical uncased section 104 that transitions into a generally horizontal uncased section 106 extending through a subterranean earth formation 108. In some embodiments, the vertical uncased section 104 may extend downwardly from a portion of the wellbore 102 having a casing string 110 cemented therein. A tubular string, such as production tubing 112, may be installed or otherwise extended into the wellbore 102.

One or more well screens 114, one or more flow control devices 116, and one or more packers 118 may be interconnected along the production tubing 112, such as along portions of the production tubing 112 in the horizontal uncased section 106 of the wellbore 102. The packers 118 may be configured to seal off an annulus 120 defined between the production tubing 112 and the walls of the wellbore 102. As a result, fluids 122 may be produced from multiple intervals or “pay zones” of the surrounding subterranean formation 108 via isolated portions of the annulus 120 between adjacent pairs of the packers 118.

As illustrated, in some embodiments, a well screen 114 and a flow control device 116 may be interconnected in the production tubing 112 and positioned between a pair of packers 118. The well screens 114 may be wire wrap screens, swell screens, sintered metal mesh screens, expandable screens, pre-packed screens, treating screens, or any other type of sand control screen known to those of skill in the art. In some embodiments, the well screens 114 may additionally include a drainage layer and/or an outer protective shroud. In some embodiments, the well screens 114 may have a mesh layer disposed about the outer perimeter of the well screens 114. In operation, the well screen 114 may be configured to filter the fluids 122 flowing into the production tubing 112 from the subterranean formation 108 and through annulus 120. The flow control device 116 may be configured to restrict or otherwise regulate the flow of the fluids 122 into the production tubing 112 based on certain physical or chemical characteristics of the fluid.

It will be appreciated by one of skill in the art that the well system 100 of FIG. 1 is merely one example of a wide variety of well systems in which the principles of the present disclosure may be utilized. Accordingly, it will be appreciated that the principles of this disclosure are not necessarily limited to any of the details of the depicted well system 100, or the various components thereof, depicted in the drawings or otherwise described herein. For example, it is not necessary in keeping with the principles of this disclosure for the wellbore 102 to include a generally vertical uncased section 104 or a general horizontal uncased section 106. Moreover, it is not necessary for the fluids 122 to be produced solely from the subterranean formation 108 since, in some embodiments, the fluids may be injected into the subterranean formation 108, or the fluids may be injected into and produced from the subterranean formation 108, without departing from the scope of the present disclosure.

Furthermore, it is not necessary that at least one well screen 114 and flow control device 116 be position between a pair of packers 118. Nor is it necessary for a single flow control device 116 to be used in conjunction with a single well screen 114. Rather, any number, arrangement, and/or combination of such components may be used, without departing from the scope of the present disclosure. In some embodiments, it is not necessary for a flow control device 116 to be used with a corresponding well screen 114. For example, in injection operations, the injected fluid could be flowed through a flow control device 116 without also flowing through a well screen 114.

In addition, it is not necessary for the well screens 114, flow control devices 116, packers 118, or any other components of the production tubing 112 to be positioned in vertical uncased section 104 or horizontal uncased section 106 of the wellbore 102. Rather, any section of the wellbore 102 may be cased or uncased, and any portion of the production tubing 112 may be positioned in an uncased or cased section of the wellbore 102, without departing from the scope of the disclosure.

Those skilled in the art will readily recognize the advantages of being able to regulate the flow of fluids 122 into the production tubing 112 from each zone of the subterranean formation 108, for example, to prevent water coning 124 or gas coning 126 in the subterranean formation 108. Other uses for flow regulation in a well may include, but are not limited to, balancing production from (or injection into) multiple zones, minimizing production (or injection) of undesired fluids, maximizing production (or injection) of desired fluids, and the like. The exemplary flow control devices 116 may provide such benefits by increasing resistance to flow if a fluid velocity increases beyond a selected level (e.g., to thereby balance flow among zones, prevent water coning 124 or gas coning 126, etc.), increasing resistance to flow if a fluid viscosity or density decreases below a selected level (e.g., to thereby restrict flow of an undesired fluid, such as water or gas, in an oil producing well), and/or increasing resistance to flow if a fluid viscosity or density increases above a selected level (e.g., to thereby minimize injection of water in a steam injection well).

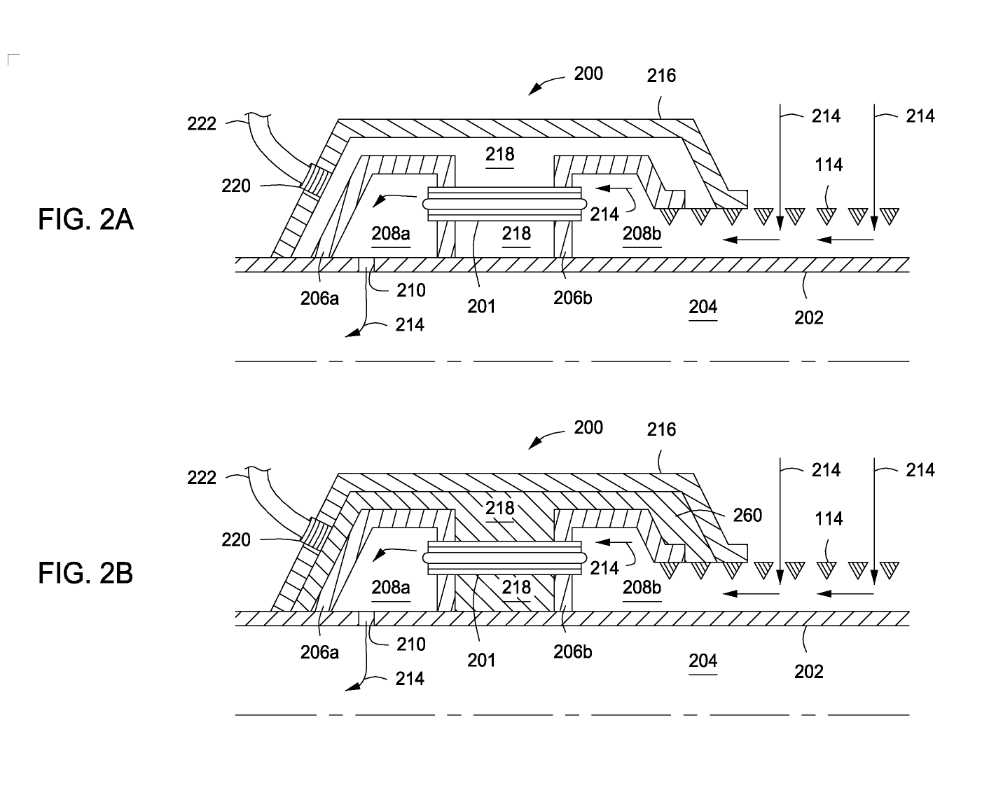

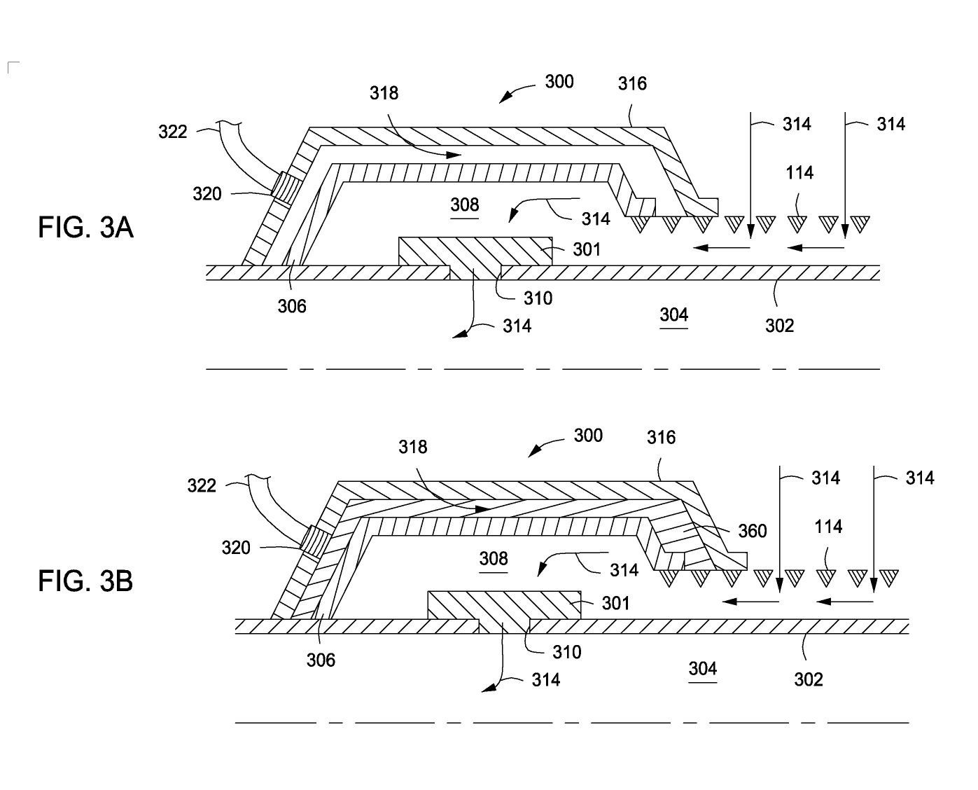

Referring now to FIG. 2A, with continued reference to FIG. 1, illustrated is an enlarged cross-sectional view of an exemplary housing assembly 200, according to one or more embodiments described herein. As illustrated, housing assembly 200 (hereinafter “assembly 200”) includes at least one flow control device 201. The flow control device 201 may be any type of flow control device known to those skilled in the art. For instance, in at least one embodiment, the flow control device 201 may be an inflow control device configured to regulate the influx of fluids during production operation. In other embodiments, however, the flow control device 201 may be use during injection operations for stimulating a surrounding subterranean formation, for example.

As depicted in FIG. 2A, the flow control device 201 is an inflow control device (hereinafter “ICD 201”). The ICD may be any ICD known to those of skill in the art. Examples of suitable ICDs may include, but are not limited to, a channel-type ICD (i.e., an ICD that imposes specific differential pressures at specified flow rates through a plurality of helical channels with preset diameters and lengths), a nozzle-type ICD (i.e., an ICD that generates pressure resistance as fluid flows and passes through a number of preconfigured nozzles, independent of fluid viscosity), or an orifice-type ICD (i.e., an ICD having a plurality of orifices of known diameter and flow characteristics that create differential-pressure resistance). The ICD 201 may be made of, for example, tungsten carbide, metal, ceramics, etc., but may be made of any other materials known to those skilled in the art. It should be noted, however, that the ICD 201 is shown and described merely for illustrative purposes and therefore should not be considered as limiting the present disclosure to the particular design or configuration depicted. For example, the ICD 201 may be sequentially arranged axially or radially in the assembly 200, without departing from the scope of the present disclosure.

A portion of one of the well screens 114 (FIG. 1) is depicted and may be operably coupled to or otherwise generally arranged about the base pipe 202 having an interior 204. The base pipe 202 may be or otherwise form a portion of the production tubing 112 of FIG. 1.

The assembly 200 may include an inner form 206, depicted as an upper inner form 206a and a lower inner form 206b, and an outer form 216. As used herein, the term “upper” refers to the uphole direction that is toward the surface of a wellbore, and the term “lower” refers to the downhole direction that is toward the bottom or toe of the wellbore. It will be appreciated that although FIG. 2A depicts the inner form 206 as having an upper inner form 206a and a lower inner form 206b, the upper and lower inner forms 206a,b may be consolidated into a single, monolithic inner form configured to support and retain the ICD 201, without departing from the scope of this disclosure.

The inner form 206 may define a fluid compartment 208, represented as an upper fluid compartment 208a, defined by the upper inner form 206a, and a lower fluid compartment 208b, defined by the lower inner form 206b. In embodiments where the upper and lower inner forms 206a,b are consolidated into a single inner form, as mentioned above, it will be appreciated that the fluid compartment 208 will then be defined by the monolithic inner form, without department from the scope of this disclosure.

As illustrated in FIG. 2A, the fluid compartment 208 may be generally defined by the inner form 206, the base pipe 202 and the well screen 114. The ICD 201 may be coupled to or otherwise arranged on the inner form 206 such that it places the upper fluid compartment 208a and the lower fluid compartment 208b in fluid communication with one another. The inner form 206 is generally arranged about the base pipe 202 and in at least one embodiment may contact or otherwise be coupled to at least a portion of well screen 114. In some embodiments, the inner form 206 may contact or otherwise be coupled to at least a portion of well screen 114 at an end that is substantially impermeable due to, for example, tight placement of the screen components relative to one another. It will be appreciated that in some embodiments, the inner form 206 may be arranged about the base pipe 202 without contacting or being coupled to the well screen 114.

The base pipe 202 may include one or more openings or flow ports 210 that place the interior 204 of the base pipe 202 in fluid communication with the fluid compartment 208. More particularly, as depicted in FIG. 2A, the flow port(s) 210 may place the interior 204 of the base pipe 202 in fluid communication with the upper fluid compartment 208a. In an exemplary embodiment, fluid 214 from the annulus 120 (FIG. 1) may be drawn through the well screen 114 and thereby be filtered before flowing into lower fluid compartment 208b. The fluid 214 may be a fluid composition originating from the surrounding formation 108 (FIG. 1) and may include one or more fluid components, such as oil and water; oil and gas; gas and water; gas and oil; oil, water, and gas; and the like. Once in the lower fluid compartment 208b, the fluid 214 may be drawn into the ICD 201 and eventually be discharged into the upper fluid compartment 208a and subsequently conveyed into the interior 204 of base pipe 202 through the flow ports 210. The ICD 201 may be configured to generally resist the flow of the fluid 214 therethrough, thereby intelligently regulating the fluid flow into the base pipe 202 at that location.

As illustrated in FIG. 2A, the inner form 206 may be nested within the outer form 216. Similar to the inner form 206, the outer form 216 may be arranged about the base pipe 202, such that it is coupled to the base pipe 202 at one end (e.g., an uphole end) and coupled to or otherwise biasing the wire screen 114 at the other end. The inner form 206 may be nested within the outer form 216 such that a sealed compartment 218 is defined between the inner form 206 and the outer form 216. According to the present disclosure, a composite resinous material may be injected into or otherwise disposed within the sealed compartment 218 in order to generate a rigid housing for the ICD 201. It will be appreciated that the size of the sealed compartment 218 may be varied so as to increase the surface area of the composite resinous material that may contact the base pipe 202, such as by increasing the axial distance between the ends of the inner form 206 and the outer form 216 coupled to the base pipe 202, without departing from the scope of the present disclosure.

Referring now to FIG. 2B, with continued reference to FIG. 2A, illustrated is a cross-sectional view of the assembly 200 following the injection of a composite resinous material 260 into the sealed compartment 218, according to one or more embodiments. The assembly 200 may include an injection port 220 defined in the outer form 216. The injection port 220 may provide a location to inject the material 260 into the sealed compartment 218. In some embodiments, a hose 222 may be operatively coupled to the injection port 220 and configured to convey or otherwise pump the composite resinous material 260 through the injection port 220 and into the sealed compartment 218. The composite resinous material 260 may then be allowed to cure or set into a hardened mass that is capable of securing the assembly 200 to the base pipe 202 without the need to use welding operations.

It will be appreciated that although FIGS. 2A, 2B depict the assembly 200 as having a single ICD 201, additional ICDs 201 may be arranged about the circumference of the base pipe 202, or may be arranged in sequence axially along the base pipe 202. Moreover, any combination of types of ICDs 201, as well as any autonomous flow control devices, may be installed using the assembly 200 described herein, without departing from the scope of the present disclosure. Additionally, a single monolithic lower inner form 206b may be used in combination with multiple ICDs 201 and multiple inner forms 216.

In some embodiments, a single monolithic outer form 216 may be used in combination with multiple ICDs and multiple inner forms. For example, a third upper inner form may be present uphole from the upper inner form 206a (i.e., in the direction away from the well screen 114, as depicted), forming a third fluid compartment in fluid communication with a second flow port. A second ICD, which may be substantially similar to ICD 201, may be coupled to or otherwise arranged on the third upper inner form and the upper inner form 206a such that it places the upper fluid compartment 208a in fluid communication with the third fluid compartment. In such embodiments, fluid 214 may be drawn through the well screen 114, into lower fluid compartment 208b, drawn through ICD 201 and into upper fluid compartment 208a. A portion of the fluid 214 may then be discharged into the interior 204 of the base pipe 202 through the flow port 210 and another portion of the fluid 214 may be drawn into the second ICD and into the third fluid chamber and eventually discharged into the interior 204 of the base pipe 202 through the second flow port. As will be appreciated, any number of additional inner forms positioned uphole from inner form 206a and associated ICDs may be daisy-chained axially together and nested within the outer form 216, without departing from the scope of the present disclosure.

Referring now to FIG. 3A, illustrated is an enlarged cross-sectional view of another exemplary housing assembly 300, according to one or more embodiments described herein. As illustrated, housing assembly 300 (hereinafter “assembly 300”) includes at least one flow control device 301, depicted as an autonomous inflow control device (hereinafter “AICD 301”). It will be appreciated that although FIG. 3A depicts the assembly 300 with only one AICD 301, any number of AICDs 301 may be included therein, as may be required for a specific operation. Moreover, any combination of types of AICDs 301, as well as any other types of flow control devices, may be installed using the assembly 300 described herein, without departing from the scope of the present disclosure. Furthermore, it should be noted that the AICD 301 is shown and described merely for illustrative purposes and therefore should not be considered as limiting the present disclosure to the particular design or configuration depicted. For example, the AICD 301 may be arranged axially or radially in the assembly 300, without departing from the scope of the present disclosure.

A portion of one of the well screens 114 (FIG. 1) is depicted and may be operably coupled to or otherwise generally arranged about a base pipe 302 having an interior 304. The base pipe 302 may be or otherwise form a portion of the production tubing 112 (FIG. 1).

The assembly 300 may include an inner form 306 that defines a fluid compartment 308, and the AICD 301 may be arranged within the fluid compartment 308. It will be appreciated that although FIG. 3A depicts the inner form 306 as a single, uninterrupted form, any other configuration may be adopted without departing from the scope of this disclosure (e.g., an inner form 306 having a plurality of portions capable of forming individual or distinct fluid compartments). The fluid compartment 308 may be generally defined by the inner form 306, the base pipe 302 and the well screen 114. In some embodiments, the AICD 301 may be coupled to the inner form 306. In other embodiments, however, as depicted in FIG. 3A, the AICD 301 may be shrink-fitted into an opening or flow port 310 in the base pipe 302, thereby securing the AICD 301 therein for long-term operation. In yet other embodiments, the AICD 301 may be threaded, brazed, or otherwise secured into the flow port 310, without departing from the scope of this disclosure.

The inner form 306 is generally arranged about the base pipe 302 and, in at least one embodiment, may contact or otherwise be coupled to a portion of well screen 114 (e.g., to the safe edge of the well screen 114, which may include a flat strip of metal or a thin metal ring welded to the end of the well screen 114 suitable for coupling the inner form 306 thereto, or a wire wrap screen capable of closing the distance between the screen openings and suitable for coupling the inner form 306 thereto). It will be appreciated that in some embodiments, the inner form 306 may be arranged about the base pipe 302 without contacting or being coupled to the well screen 114.

The base pipe 302 may include the flow port 310 such that the fluid compartment 308 is in fluid communication with the interior 304 of the base pipe 302. In an exemplary embodiment, fluid 314 from the annulus 120 (FIG. 1) may be drawn through the well screen 114 and thereby be filtered before flowing into lower fluid compartment 308. The fluid 314 may be a fluid composition originating from the surrounding formation 108 (FIG. 1) and may include one or more fluid components, such as oil and water; oil and gas; gas and water; gas and oil; oil, water, and gas; and the like. Once in the fluid compartment 308, the fluid 314 may enter the AICD 301 and eventually be discharged therefrom into the interior 304 of base pipe 302 through one or more flow ports 310 (one shown). The AICD 301 may resist the flow of a fluid 314 therethrough based on one or more characteristics of the fluid 314, such as density, viscosity, and/or velocity of the fluid or its various components.

The AICD 301 may be made of, for example, tungsten carbide, but may be made of any other materials known to those skilled in the art. It should be noted, however, that the AICD 301 is shown and described merely for illustrative purposes and therefore should not be considered as limiting the present disclosure to the particular design or configuration depicted. One of skill in the art will readily appreciate that there are several AICD 301 designs and/or configurations that could equally be used in accordance with the principles disclosed herein, without departing from the general scope of this disclosure.

As illustrated in FIG. 3A, the inner form 306 may be nested within an outer form 316. The outer form 316 may be arranged about the base pipe 302, such that it is coupled to the base pipe 302 at one end and coupled to the wire screen 114 at the other end (e.g., to the safe edge of the wire screen 114). The inner form 306 may be nested within the outer form 316 such that sealed compartment 318 is formed between the inner form 306 and the outer form 316. An injection port 320 may be defined in the outer form 316 and coupled to a hose 322.

Referring now to FIG. 3B, composite resinous material 360 may be pumped into hose 322, through injection port 320 and into sealed compartment 318. The composite resinous material 360 may then be allowed to cure or set into a hardened mass that is capable of sealing the assembly 300 to the base pipe 302 without welding operations. It will be appreciated that the size of the sealed compartment 318 may be varied so as to increase the surface area of the composite resinous material 360 that may contact the base pipe 302, such as by increasing the axial distance between the ends of the inner form 306 and the outer form 316 coupled to the base pipe 302, without departing from the scope of the present disclosure. The hose 322 and/or the injection port 320 may be removed from the outer form 316 prior to introducing the base pipe 302 into a subterranean formation. In some embodiments, the injection port 320 may remain in contact with the outer form 316 as the base pipe 302 it is placed into a subterranean formation.

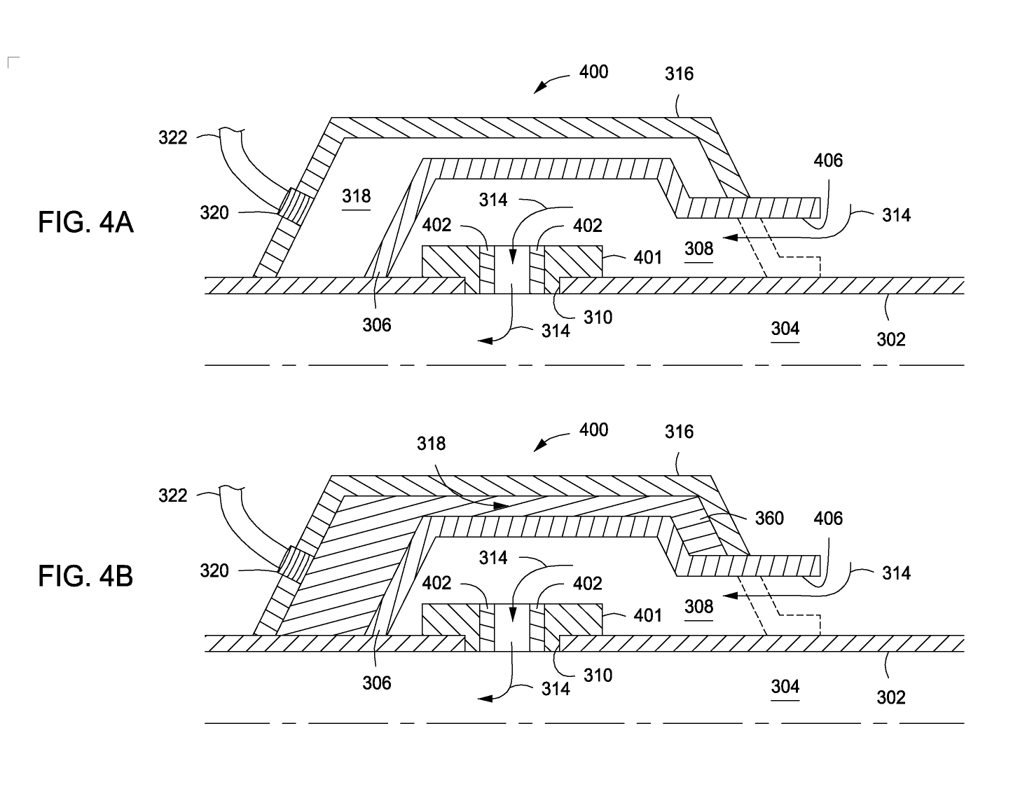

Referring now to FIGS. 4A and 4B, illustrated is an enlarged cross-sectional view of an exemplary housing assembly 400 (hereinafter “assembly 400”), according to one or more embodiments described herein. The assembly 400 depicted in FIGS. 4A and 4B may be similar in some respects to the assembly 300 of FIGS. 3A and 3B, and, therefore, may be best understood with reference thereto, where like numerals refer to like elements not described again in detail.

As illustrated, the assembly 400 includes at least one flow control device 401 shrink-fitted into at least one flow port 310. The flow control device 401 may be, for example, a nozzle or restrictor orifice known to those skilled in the art. In other embodiments, however, the flow control device 401 may be positioned at or near the flow port 310 in any configuration, and may be any type of ICD or AICD described herein. In one embodiment, the flow port 310 may have an epoxy or other hardenable material disposed on about the diameter of the flow port 310, so as to reduce the opening size of the flow port 310, thereby permitting the flow control device 401 to be positioned in fluid communication with the flow port 310 without being shrink-fitted therein. In other embodiments, the flow control device 401 may be encased in an epoxy or other hardenable material without compromising the flow path therethrough, the epoxy providing increased axial contact area to arrange the flow control device 401 about the base pipe 302, thereby permitting the flow control device 401 to be positioned in fluid communication with the flow port 310 without being shrink-fitted therein. The flow control device 401 may include an erosion resistant material 402 included therein. The erosion resistant material 402 may resist the velocity and pressure imposed by the fluids 314 flowing past the flow control device 401, thereby extending the life of the flow control device 401.

It will be appreciated that although FIG. 4A depicts a nozzle-type flow control device 401, any type of flow control device may be used, without departing from the scope of the present disclosure. Moreover, the flow control device 401 need not have included therein an erosion resistant material 402, and where such an erosion resistant material 402 is included within the flow control device 401, it may be included in any configuration, provided that the erosion resistant material 402 does not interfere with the flow of fluids 314 through the flow control device 401 and into the interior 304 of base pipe 302 through the flow port 310.

As illustrated, the assembly 400 may include the inner form 306 and the outer form 316. The inner form 306 may be arranged about the base pipe, such that it is coupled to the base pipe 302 at one end and defines or otherwise provides one or more arched flow conduits 406 that provide fluid communication between the fluid compartment 308 and the annulus 120 (FIG. 1).

The inner form 306 may be nested within the outer form 316 by coupling at least one end of the outer form 316 to the base pipe 302 and coupling or otherwise draping the other end to the inner form 306 at the arched flow conduit 406, thereby forming a sealed compartment 318 between the inner and outer forms 306, 316. More particularly, the outer form 316 may be configured to be draped or otherwise extend over the arched flow conduit(s) 406 of the inner form 306 so as to increase the contact surface area between the inner and outer forms 306, 316 at that location. As will be appreciated, this may prove advantageous in allowing the forms 306, 316 to resist increased pressures during injection of a composite resinous material through an injection port 320 defined in the outer form 316.

Referring to FIG. 4B, a composite resinous material 360 may be pumped into the sealed compartment 318 via a hose 322 coupled to the port 320 and allowed to form a hardened mass capable of sealing the assembly 400 to the base pipe 302 without welding operations. As with prior embodiments, the size of the sealed compartment 318 may be varied so as to increase the surface area of the composite resinous material 360 that may contact the base pipe 302, such as by increasing the axial distance between the ends of the inner form 306 and the outer form 316 coupled to the base pipe 302, without departing from the scope of the present disclosure.

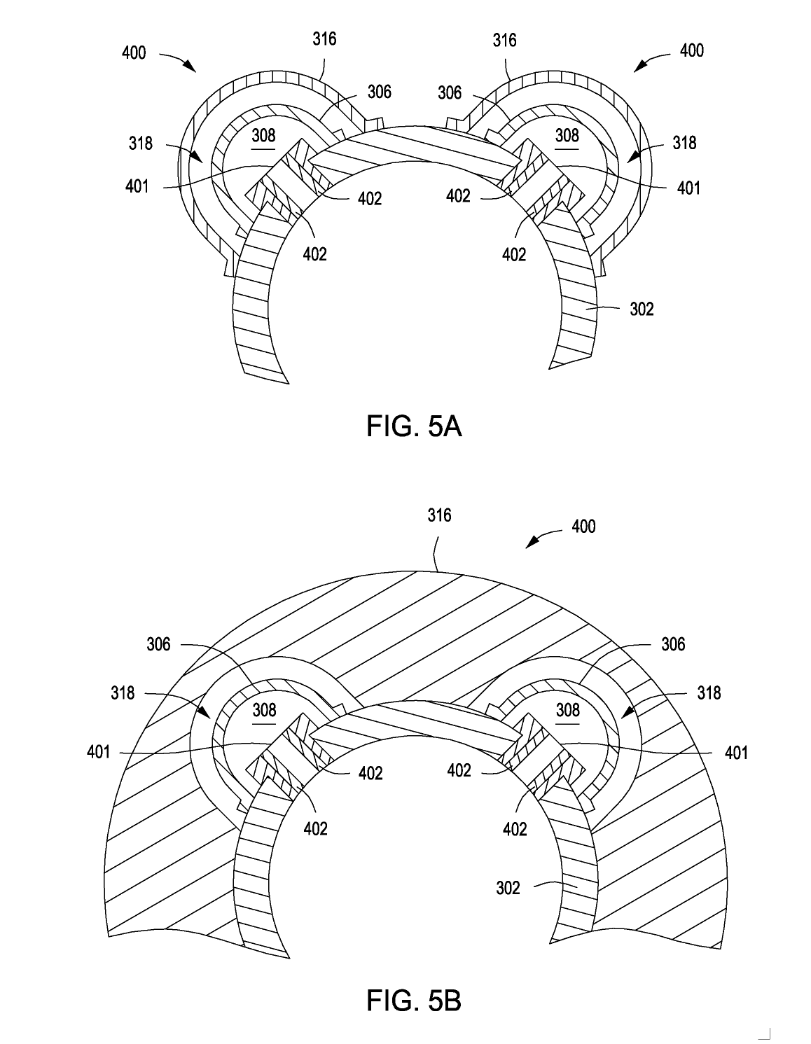

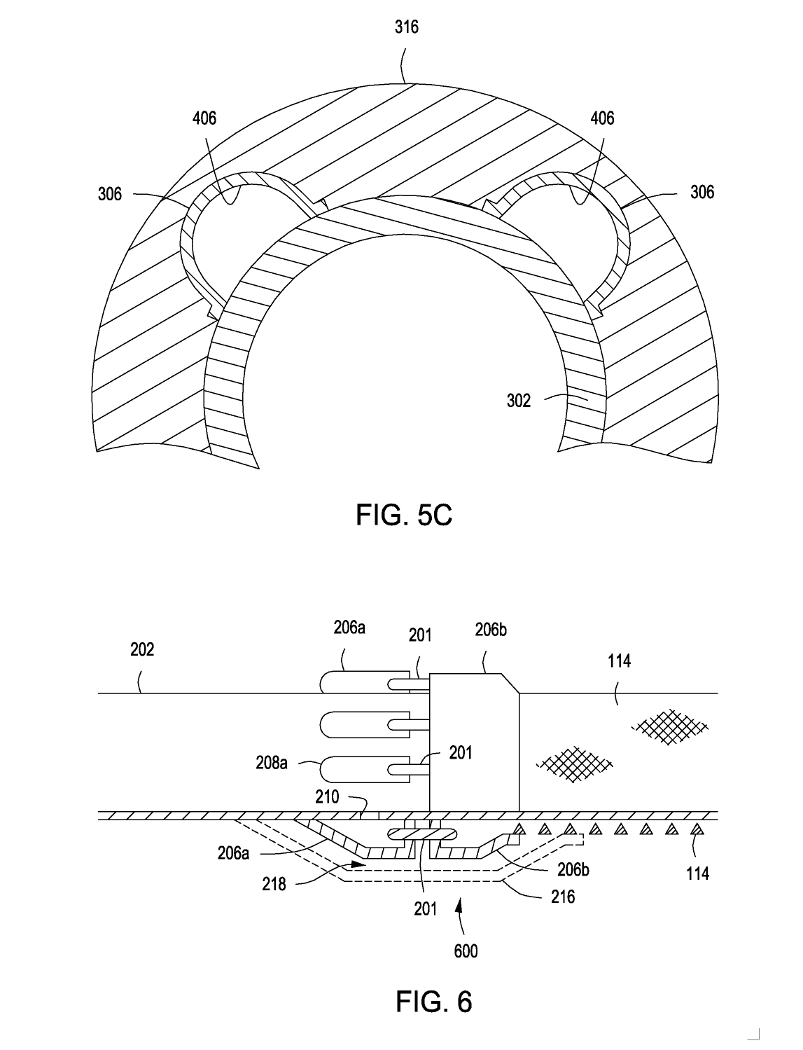

Referring now to FIGS. 5A-5C, illustrated are enlarged cross-sectional end views of the exemplary housing assembly 400 of FIGS. 4A from different perspectives. As illustrated in FIG. 5A, one or more (two shown) assemblies 400 may be mounted about the circumference of the base pipe 302. It will be appreciated that although the assemblies 400 are depicted as being angularly offset from each other about the circumference of the base pipe 302, the assemblies 400 may equally be axially offset along the base pipe 302, without departing from the scope of the disclosure. In the depicted embodiment, the assemblies 400 each include the flow control device 401 having erosion resistant material 402 included therein, as generally described with reference to FIG. 4A. The inner forms 306 each form a distinct fluid compartment 308 and are nested within corresponding outer forms 316, thereby forming sealed compartments 318 therebetween into which the composite resinous material 360 (FIG. 4B) may be injected to seal the assemblies 400 to the base pipe 302.

Referring to FIG. 5B, in at least one embodiment, the assembly 400 may include a single monolithic outer form 316 having nested therein multiple inner forms 306 forming multiple fluid compartments 308 in fluid communication with the annulus 120 (FIG. 1) and the flow control device 401. The single monolithic outer form 316 may form multiple sealed compartments 318 defined between corresponding inner surfaces of the outer form 316 and outer surfaces of each inner form 306.

Referring to FIG. 5C, illustrated is the one or more arched flow conduits 406 of the inner form 306 and corresponding portions of the outer form 316 draped or otherwise coupled thereto and in direct contact with each other. As will be appreciated, draping a portion of the outer form 316 over the arched flow conduits 406 may prove advantageous in increasing the surface area or contact area for coupling the inner and outer forms 306, 316. More particularly, the increased surface area may maximize an area for bonding the inner form 306 to the outer form 316, thus allowing the two bonded components to withstand increased pressures, such as those experienced while pumping the composite resinous material 360 (FIG. 4B) into the sealed compartment 318 (not shown) defined between the inner form 306 and the outer form 316.

Referring now to FIG. 6, illustrated is a partial cross-sectional view of another exemplary housing assembly 600, according to one or more embodiments described herein. The assembly 600 may be similar in some respects to the assembly 200 of FIGS. 2A, 2B, and, therefore, may be best understood with reference thereto, where like numerals refer to like elements not described again in detail. As illustrated, the assembly 600 may be arranged about the base pipe 202 and include a single monolithic lower inner form 206b and multiple upper inner forms 206a arranged circumferentially about the base pipe 202. Multiple ICDs 201 extend between the several upper inner forms 206a and the single monolithic lower inner form 206b. The single monolithic lower inner form 206b may contact or otherwise be coupled to at least a portion of the well screen 114 at one end, as depicted. It will be appreciated, however, that in some embodiments, the lower inner form 206b may be arranged about the base pipe 202 without contacting or being coupled to the well screen 114, and instead a shroud or other sleeve-type mechanism may extend between the well screen 114 and the lower inner form 206b. Additionally, although depicted as a single monolithic lower inner form 206b, corresponding lower inner forms 206b may equally be paired with each upper inner form 206a and corresponding ICD 201, without departing from the scope of the present disclosure.

As depicted in phantom, an outer form 216 may be arranged about the base pipe 202, such that it is coupled to the base pipe 202 at one end (e.g., an uphole end) and may be coupled to or otherwise biasing the well screen 114 at the other end. The outer form 216 may be configured to axially encompass the upper and lower inner forms 206a,b such that each is disposed within the outer form 216 and the sealed compartment 218 is defined therebetween. In at least one embodiment, the outer form 216 may encompass or otherwise enclose the upper and lower inner forms 206a,b and a single ICD 201 may provide fluid communication between the upper and lower inner forms 206a,b.

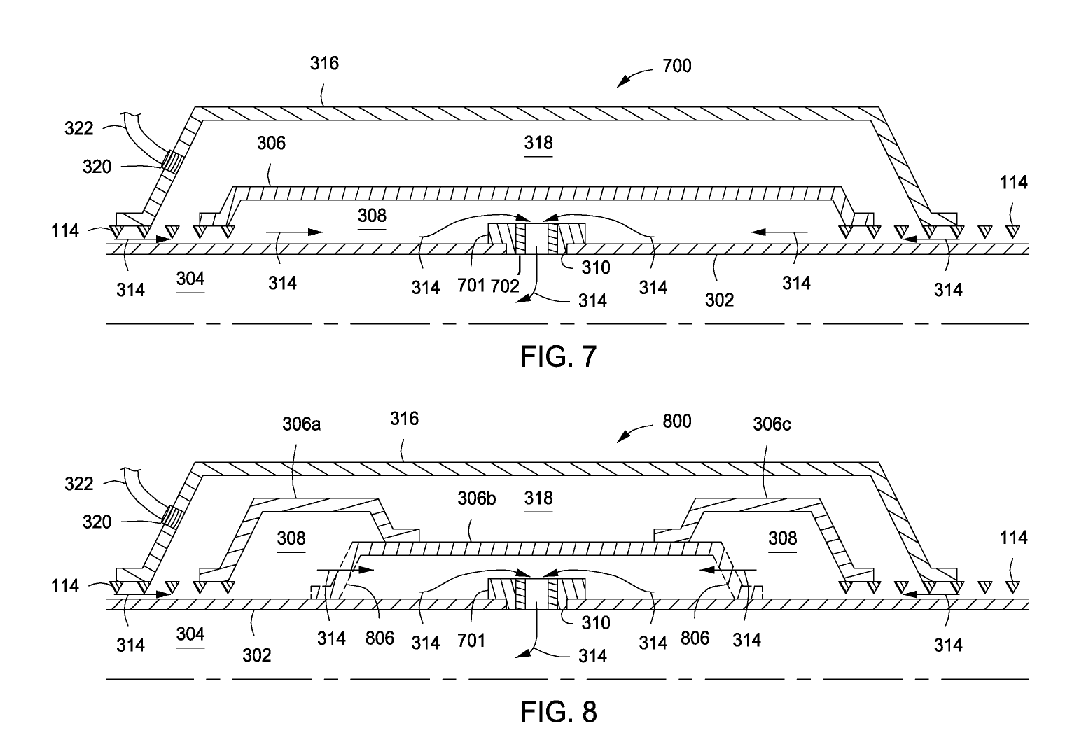

Referring now to FIG. 7, illustrated is an enlarged cross-sectional view of another exemplary housing assembly 700 (hereinafter “assembly 700”), according to one or more embodiments described herein. The assembly 700 may be similar in some aspects to the assembly 300 depicted in FIGS. 3A, 3B and, therefore, may be best understood with reference thereto, where like numerals refer to like elements not described again in detail.

As illustrated, the assembly 700 includes at least one flow control device 701 arranged within the flow port 310. In other embodiments, the flow control device 701 may be positioned at or near the flow port 310 in any configuration, such as those described herein. As depicted, the flow control device 701 may have erosion resistant material 702 included therein. It will be appreciated, however, that flow control device 701 need not have erosion resistant material 702 included therein, without departing from the scope of the present disclosure. Moreover, it will appreciated that any type, number, and combination of flow control devices 701 may be used in the embodiments described herein, without departing from the scope of the present disclosure.

As illustrated, the assembly 700 may include the inner form 306 and the outer form 316. The inner form 306 may include a first end and a second end and may be generally arranged about the base pipe 302 and contact or otherwise be coupled to at least a portion of the well screen at its first end and at its second end. A fluid compartment 308 may be generally defined by the inner form 306, the base pipe 302, and the well screen 114, the flow port 310 being disposed therein, such that the inner form 306 axially spans the flow port 310. The flow port 310 may place the interior 304 of the base pipe 302 in fluid communication with the fluid compartment 308. In exemplary embodiments, fluid 314 from the annulus 120 (FIG. 1) may be drawn through the well screen 114 either uphole or downhole from the assembly 700, through the flow control device 701 and eventually discharged into the interior 304 of the base pipe 302 through flow port 310. In other embodiments, such as during injection operations, fluid may be injected through the interior 304 of the base pipe 302, into the flow control device 701 through flow port 310, through well screen 114, either uphole or downhole from the flow port 310, and eventually into the annulus 120 (FIG. 1).

The inner form 306 may be nested within the outer form 316. Similar to the inner form 306, the outer form 316 may have a first end and a second end and may be arranged about the base pipe 302, such that it contacts or is otherwise coupled to at least a portion of the well screen at its first end and its second end, thereby spanning the flow port 310 and defining sealed compartment 318 between the inner form 306 and the outer form 316. As shown, the outer form may further include an injection port 320 through which a composite resinous material (not shown) may be injected into the sealed compartment 318 via a hose 322. The composite resinous material may then be allowed to cure or set into a hardened mass that is capable of securing assembly 700 to the well screen 114 and base pipe 302 without the need to use welding operations.

In some embodiments, the fluid 314 may drawn into the fluid compartment 308 through the well screen 114 at either the first end or the second end of the inner form 306 (i.e., either uphole or downhole from the assembly 700), drawn into the flow control device 701 and discharged into the interior 304 of the base pipe 302 through flow port 310. In other embodiments, due to the tendency of the fluid 314 to follow the path of least resistance, a portion of the fluid 314 may be drawn through the well screen 114 portion uphole from the assembly 700, into the fluid compartment 308, and into the flow control device 701, while another portion of the fluid 314 may follow the path of least resistance and exit the assembly 700 through the well screen 114 portion downhole from the assembly 700 (i.e., flow past the flow control device 701). In other embodiments, a portion of the fluid 314 may be drawn through the well screen 114 portion downhole from the assembly 700, into the fluid compartment 308, and into the flow control device 701, while another portion of the fluid 314 may follow the path of least resistance and exit the assembly 700 through the well screen 114 portion uphole from the assembly 700 (i.e., flow past the flow control device 701).

Referring now to FIG. 8, illustrated is an enlarged cross-sectional view of another exemplary housing assembly 800 (hereinafter “assembly 800”), according to one or more embodiments described herein. The assembly 800 may be substantially similar in some aspects to the assembly 700 depicted in FIG. 7 and, therefore, may be best understood with reference thereto, where like numerals refer to like elements not described again in detail.

As depicted, the assembly 800 may include the inner form 306 (depicted as an upper inner form 306a, a middle inner form 306b, and a lower inner form 306c) and the outer form 316. The inner forms 306a-c may cooperatively define the fluid compartment 308 into which fluids 314 may be drawn from the annulus 120 (FIG. 1) and the well screen 114. Once in the fluid compartment 308 the fluids 314 may pass through the flow control device 701 and into the interior 304 of the base pipe 302.

The upper inner form 306a may be arranged about the base pipe 302 and in contact with or otherwise coupled to the well screen 114 at one end and the middle inner form 306b at the other end. Similarly, the lower inner form 306c may be arranged about the base pipe and in contact with or otherwise coupled to the well screen 114 at one end and the middle inner form 306b at the other end. Thus, the middle inner form 306b may interpose the upper and lower inner forms 306a,c. In some embodiments, the middle inner form 306b may define or otherwise provide one or more flow channels 806 at one or both ends of the middle inner form 306b (two shown). The flow channels 806 may include or otherwise define openings or ports configured to allow fluid communication between the fluid compartment 308 and the well screen 114.

The inner form 306a-c may be nested within the outer form 316. The outer form 316 may have opposing first and second ends and may be arranged about the base pipe 302 such that it is in contact with or is otherwise coupled to at least a portion of the well screen 114 at the first and second ends. The sealed compartment 318 is defined between the inner form 306a-c and the outer form 316. As shown, the outer form 316 may further include an injection port 320 through which a composite resinous material (not shown) may be injected into the sealed compartment 318 via a hose 322. The composite resinous material may then be allowed to cure or set into a hardened mass that is capable of securing the assembly 800 to the well screen 114 and the base pipe 302 without the need to use welding operations.

The inner forms 206, 306 and the outer forms 216, 316 described herein may each be made of any material suitable for use in wellbore operations. The inner forms 206 and 306 and/or the outer forms 216 and 316 may be rigid or semi-rigid, provided that they are capable of withstanding any pressure exerted by the composite resinous material as it is pumped therebetween and/or as it sets. Suitable materials for forming the inner forms 206 and 306 and the outer forms 216 and 316 may include, without limitation, a metal (e.g., aluminum, steel, zinc, and the like); a metal alloy (e.g., zinc alloy, bronze alloy, and the like); a metal carbide; zirconia; titania; alumina; a thermoset plastic (e.g., polyurathanes, polyesters, epoxy resins, phenolic resins, and the like); polystyrene; polyvinyl chloride; polytetrafluoroethylene; an aliphatic polyamide; plaster; and any combination thereof.

In some embodiments, the outer forms 216 and 316 may be removed from the composite resinous material after it has cured by mechanical means (e.g., by cutting, by prying off, and the like). In other embodiments, the inner forms 206 and 306 and/or the outer forms 216 and 316 may be dissolvable or degradable over time or upon contact with a degradation stimulant (e.g., temperature, pH, salinity, and the like) after the composite resinous material has cured. The inner forms 206 and 306 and/or the outer forms 216 and 316 may be degraded prior to introducing the base pipe 202 and 302 into a subterranean formation or thereafter, which may allow degradation upon exposure to downhole conditions (e.g., temperature, pH, salinity, and the like). In some embodiments, the inner forms 206 and 306 and/or the outer forms 216 and 316 may be formed from heavy metals (e.g., lead, zinc, mercury, and the like) that can be degraded or dissolved upon exposure to a brine solution.

In some embodiments, the inner forms 206 and 306 and/or the outer forms 216 and 316 may be formed from oil-degradable polymers that may degrade upon contact with an oil-based fluid. As such, the oil-degradable polymers may degrade downhole upon contact with production fluids (i.e., hydrocarbons) or may be washed with an oil-based fluid prior to placement downhole. The oil-degradable polymers may be natural polymers or synthetic polymers. Suitable oil-degradable polymers that may be used as material to construct the inner forms 206 and 306 and/or the outer forms 216 and 316 may include, but are not limited to, a polyamide; a polyolefin (e.g., polyethylene, polypropylene, polyisobutylene, polystyrene, and the like), and any combination thereof. Other suitable oil-degradable polymers may include those that have a melting point that is such that the polymer will dissolve at a particular temperature, such as the temperature of the subterranean formation in which it is placed, such as a wax material.

In addition to oil-degradable polymers, other degradable materials that may be used in conjunction with the embodiments of the present disclosure may include, but are not limited to, degradable polymers; dehydrated salts; and any combination thereof. As used herein, a polymer is considered to be “degradable” if the degradation is due to a chemical and/or radical process such as hydrolysis, oxidation, or UV radiation, which may occur in situ in the subterranean formation. The degradability of a polymer depends at least in part on its backbone structure. For instance, the presence of hydrolyzable and/or oxidizable linkages in the backbone often yields a material that will degrade as described herein. The rates at which such polymers degrade are dependent on a number of factors including, but not limited to, the type of repetitive unit, composition, sequence, length, molecular geometry, molecular weight, morphology (e.g., crystallinity, size of spherulites, and orientation), hydrophilicity, hydrophobicity, surface area, and additives. Also, the environment to which the polymer is subjected may affect how it degrades (e.g., temperature, presence of moisture, oxygen, microorganisms, enzymes, pH, and the like).

Suitable examples of degradable polymers that may be used in accordance with the embodiments of the present disclosure may include, but are not limited to, polysaccharides (e.g., dextran or cellulose); chitins; chitosans; proteins; aliphatic polyesters; poly(lactides); poly(glycolides); poly(ε-caprolactones); poly(hydroxybutyrates); poly(anhydrides) (e.g., poly(adipic anhydride), poly(suberic anhydride), poly(sebacic anhydride), poly(dodecanedioic anhydride), poly(maleic anhydride), and poly(benzoic anhydride)); aliphatic or aromatic polycarbonates; poly(orthoesters); poly(amino acids); poly(ethylene oxides); polyphosphazenes; and any combination thereof. Of these suitable polymers, aliphatic polyesters and polyanhydrides may be preferred.

Dehydrated salts may be used in accordance with the embodiments of the present disclosure as a degradable material. A dehydrated salt is suitable for use in the embodiments of the present disclosure if it will degrade over time as it hydrates. For example, a particulate solid anhydrous borate material that degrades over time may be suitable. Specific examples of particulate solid anhydrous borate materials that may be used include, but are not limited to, anhydrous sodium tetraborate (also known as anhydrous borax) and anhydrous boric acid. In some instances, the total time required for the anhydrous borate materials to degrade in the presence of an aqueous fluid is in the range of from about 8 hours to about 72 hours depending upon the temperature to which they are exposed. Other examples include organic or inorganic salts like acetate trihydrate.

Blends of certain degradable materials may also be suitable. One example of a suitable blend of materials is a mixture of poly(lactic acid) and sodium borate where the mixing of an acid and base could result in a neutral solution where this is desirable. Another example would include a blend of poly(lactic acid) and boric oxide. Other materials that undergo an irreversible degradation may also be suitable, if the products of the degradation do not undesirably interfere with assembly 600 or assembly 300.

In some embodiments, the composite resinous material may further comprise an additive including, but not limited to, a filler particle; an activator; a catalyst; a hardening agent; a bonding agent; an accelerator; a solvent; and any combination thereof.

The composite resinous material for use in the embodiments described herein may include a resin, or a resin and filler particles. The hard particles may be made of any material that does not adversely react with the resin or any additives that may be included in the composite resinous material or with the subterranean formation, and may in exemplary embodiments be hard filler particles capable of at least partially resisting high shear. Examples of suitable filler particles may include, but are not limited to, include ceramic; silica; glass; clay; alumina; fumed silica; carbon black; graphite; mica; meta-silicate; calcium silicate; calcine; kaoline; talc; zirconia; titanium dioxide; fly ash; boron; and any combination thereof. In exemplary embodiments, the filler material is ceramic. In some embodiments, the filler particles may range in average size of a lower limit of about 0.01 μm, 1 μm, 5 μm, 10 μm, 15 μm, 20 μm, 25 μm, 30 μm, 35 μm, 40 μm, 45 μm, and 50 μm to an upper limit of about 100 μm, 95 μm, 90 μm, 85 μm, 80 μm, 75 μm, 70 μm, 65 μm, 60 μm, 55 μm, and 50 μm. In some embodiments, filler particles having a smaller average size may be preferred. In certain embodiments, the filler particles may be included in the composite resinous material in an amount of a lower limit of about 0.1%, 1%, 5%, 10%, 15%, 20%, 25%, and 30% to an upper limit of about 70%, 60%, 55%, 50%, 45%, 40%, 35%, and 30% by weight of the composite resinous material. In other embodiments, the filler particles may be included in the composite resinous material in an amount of about 0.5% to about 40% by weight of the composite resinous material. In some embodiments, the filler particles may be included in the composite resinous material in an amount of about 1% to about 10% by composite resinous of the resin composition.

Suitable resins for use in forming the composite resinous material include any resin capable adhering to a base pipe (e.g., production tubing 112 (FIG. 1)) and forming a hardened, consolidated mass, which does not become dissociated from the base pipe under normal shear conditions within a subterranean formation during any particular formation operation. Specific examples of suitable resins may include, but are not limited to, a two component epoxy based resin; a novolak resin; a polyepoxide resin; a phenol-aldehyde resin; a urea-aldehyde resin; a urethane resin; a phenolic resin; a furan resin; a furan/furfuryl alcohol resin; a phenolic/latex resin; a phenol formaldehyde resin; a silicon-based resin; a polyester resin; a polyester copolymer resin; a polyester hybrid resin; a polyurethane resin; a polyurethane copolymer resin; a polyurethane hybrid resin; an acrylate resin; a silicon-based resin; and any combination thereof.

Some suitable resins, such as epoxy resins, may be cured with an internal catalyst or activator so that when pumped down hole, they may be cured using only time and temperature. Other suitable resins, such as furan resins generally require a time-delayed catalyst or an external catalyst to help activate the polymerization of the resins if the cure temperature is low (i.e., less than 250° F. (121.1° C.), but will cure under the effect of time and temperature if the formation temperature is above about 250° F. (121.1° C.), preferably above about 300° F. (148.8° C.). It is within the ability of one skilled in the art, with the benefit of this disclosure, to select a suitable resin for use in embodiments of the present disclosure and to determine whether a catalyst is required to trigger curing. By way of example, a silicon-based resin system as may be used as a more eco-friendly choice in cases where epoxy or furan-based resins pose environmental concerns.

Examples of the hardening agents that may be used in the composite resinous material may include, but are not limited to, a cyclo-aliphatic amine (e.g., piperazine, derivatives of piperazine (e.g., aminoethylpiperazine), and modified piperazines); an aromatic amine (e.g., methylene dianiline, derivatives of methylene dianiline, and hydrogenated forms, and 4,4′-diaminodiphenyl sulfone); an aliphatic amine (e.g., ethylene diamine, diethylene triamine, triethylene tetraamine, and tetraethylene pentaamine); imidazole; pyrazole; pyrazine; pyrimidine; pyridazine; 1H-indazole; purine; phthalazine; naphthyridine; quinoxaline; quinazoline; phenazine; imidazolidine; cinnoline; imidazoline; 1,3,5-triazine; thiazole; pteridine; indazole; an amine; a polyamine; an amide; a polyamide; 2-ethyl-4-methyl imidazole; and any combination thereof. The chosen hardening agent often affects the range of temperatures over which the composite resinous material is able to cure. By way of example, and not of limitation, at temperatures of about 60° F. (15.6° C.) to about 250° F. (121.1° C.), amines and cyclo-aliphatic amines, such as piperidine, triethylamine, tris(dimethylaminomethyl)phenol, and dimethylaminomethyl)phenol may be preferred. At higher temperatures, 4,4′-diaminodiphenyl sulfone may be a suitable hardening agent. Hardening agents that comprise piperazine or a derivative of piperazine may be preferred over a wide temperature range of as low as about 50° F. (10° C.) to as high as about 350° F. (176.7° C.).

A bonding agent in the form of a silane coupling agent may be used, among other things, to act as a mediator to help bond the resin to a base pipe (e.g., production tubing 112 (FIG. 1)). Examples of suitable bonding agents may include, but are not limited to, N-2-(aminoethyl)-3-aminopropyltrimethoxysilane, and 3-glycidoxypropyltrimethoxysilane, and combinations thereof. The silane coupling agent may be included in the composite resinous material according to the chemistry of the particular group as determined by one skilled in the art with the benefit of this disclosure.

Optionally, the composite resinous material may further comprise a curing agent to facilitate or accelerate curing of the composite resinous material, such as at low temperatures. Examples of suitable curing agents may include, but are not limited to, organic or inorganic acids (e.g., maleic acid, fumaric acid, sodium bisulfate, hydrochloric acid, hydrofluoric acid, acetic acid, formic acid, phosphoric acid, sulfonic acid); alkyl benzene sulfonic acids (e.g., toluene sulfonic acid and dodecyl benzene sulfonic acid (“DDBSA”)); and any combination thereof.

Any solvent that is compatible with the composite resinous material achieves a desired viscosity effect may be suitable for use in the composite resinous material described herein. Suitable solvents may include, but are not limited to, butyl lactate; dipropylene glycol methyl ether; dipropylene glycol dimethyl ether; dimethyl formamide; diethyleneglycol methyl ether; ethyleneglycol butyl ether; diethyleneglycol butyl ether; propylene carbonate; methanol; butyl alcohol; d'limonene; fatty acid methyl ester; butylglycidyl ether; isopropanol; butanol; glycol ether; and any combination thereof. Suitable glycol ether solvents may include, but are not limited to, diethylene glycol methyl ether; dipropylene glycol methyl ether; 2-butoxy ethanol; ethers of a C2 to C6 dihydric alkanol containing at least one C1 to C6 alkyl group; mono ethers of dihydric alkanols; methoxypropanol; butoxyethanol; hexoxyethanol; and isomers thereof. Selection of an appropriate solvent is dependent on the resin chosen for use in the composite resinous material and is within the ability of one skilled in the art, with the benefit of this disclosure.

The composite resinous material described herein may be provided as a two-part raw material system for admixing for molding whereby the whole can be reacted. The reaction may be catalytically controlled such that the various components in the separated two parts of the composite resinous material will not react until they are brought together under suitable molding conditions. Thus, one part may include an activator, or an accelerator, or a hardening agent required to promote, initiate, or facilitate the reaction between whole mixed material. The appropriate balance of components may be achieved by using pre-calibrated mixing and dosing equipment.

Embodiments disclosed herein include:

A. A housing assembly, comprising: an outer form arranged about a base pipe, the base pipe including at least one flow port; an inner form arranged about the base pipe and nested within the outer form, thereby defining a sealed compartment between the outer and inner forms; and a composite resinous material disposable within the sealed compartment and curable to form a rigid housing arranged at or near the at least one flow port and in fluid communication therewith.

B. A system, comprising: a base pipe; a housing assembly arranged about the base pipe, the base pipe including at least one flow port, wherein the housing assembly includes an outer form arranged about the base pipe, and an inner form arranged about the base pipe and nested within the outer form, thereby defining a sealed compartment between the outer and inner forms; and a composite resinous material disposable within the sealed compartment and curable to form a rigid housing arranged at or near the at least one flow port and in fluid communication therewith.

C. A method, comprising: arranging a housing assembly about a base pipe, the base pipe including at least one flow port, the housing assembly including an outer form arranged about the base pipe, and an inner form arranged about the base pipe and nested within the outer form, thereby defining a sealed compartment between the outer and inner forms; pumping a composite resinous material into the sealed compartment; and curing the composite resinous material to form a rigid housing arranged at or near the at least one flow port and in fluid communication therewith.

Each of embodiments A, B, and C may have one or more of the following additional elements in any combination:

Element 1: Wherein the outer form is coupled to at least one end of a well screen.

Element 2: Wherein the inner form is coupled to at least one end of the well screen.

Element 3: Wherein the inner form defines at least one arched flow conduit.

Element 4: Wherein at least one flow control device is arranged at or near the at least one flow port.

Element 5: Wherein at least one flow control device is arranged at or near the at least one flow port, and wherein the at least one flow control device is an inflow control device or an autonomous inflow control device.

Element 6: Further comprising an injection port defined in the outer form and providing a location where the composite resinous material is able to be disposed within the sealed compartment.

Element 7: Wherein at least one of the inner and outer forms is formed from a material selected from the group consisting of a metal, a metal alloy, a metal carbide, zirconia, titania, alumina, a thermoset plastic, polystyrene, polyvinyl chloride, polytetrafluoroethylene, an aliphatic polyamide, plaster, an oil-degradable polymer, a degradable polymer, a dehydrated salt, and any combination thereof.

Element 8: Wherein the composite resinous material is selected from the group consisting of a two component epoxy based resin, a novolak resin, a polyepoxide resin, a phenol-aldehyde resin, a urea-aldehyde resin, a urethane resin, a phenolic resin, a furan resin, a furan/furfuryl alcohol resin, a phenolic/latex resin, a phenol formaldehyde resin, a silicon-based resin, a polyester resin, a polyester copolymer resin, a polyester hybrid resin, a polyurethane resin, a polyurethane copolymer resin, a polyurethane hybrid resin, an acrylate resin, a silicon-based resin, and any combination thereof.

Element 9: Wherein the composite resinous material further comprises an additive selected from the group consisting of a filler particle, an activator, a catalyst, a hardening agent, a bonding agent, an accelerator, a solvent, and any combination thereof.

Element 10: Wherein the inner form comprises an upper inner form and a lower inner form.

Element 11: Wherein the inner form comprises an upper inner form and a lower inner form, and wherein at least one flow control device extends between the upper inner form and the lower inner form.

Element 12: Wherein the inner form comprises an upper inner form, a middle inner form, and a lower inner form.

Element 13: Wherein the outer form is removable after curing the composite resinous material.

Element 14: Further comprising coupling the outer form to at least one end of a well screen.

Element 15: Further comprising coupling the outer form to at least one end of a well screen and coupling the inner form to at least one end of the well screen.

Element 16: Wherein arranging the housing assembly about the base pipe further comprises coupling the inner form to one end of a well screen.

Element 17: Further comprising drawing into the rigid housing and through the at least one flow port.

Element 18: Wherein arranging the housing assembly about the base pipe further comprises coupling the inner form at a first end and at a second end to a well screen.

Element 19: Wherein arranging the housing assembly about the base pipe further comprises coupling the inner form at a first end and at a second end to a well screen, and further comprising drawing a fluid into the rigid housing through a portion of the well screen coupled to the inner form at the first end, wherein a first portion of the fluid is discharged through the at least one flow port and a second portion of the fluid is discharged through a portion of the well screen coupled to the inner form at the second end.

Element 20: Wherein arranging the housing assembly about the base pipe further comprises coupling the inner form at a first end and at a second end to a well screen, and further comprising drawing a fluid into the rigid housing through a portion of the well screen coupled to the inner form at the second end, wherein a first portion of the fluid is discharged through the at least one flow port and a second portion of the fluid is discharged through a portion of the well screen coupled to the inner form at the first end.

Element 21: Further comprising arranging at least one flow control device at or near the at least one flow port.

Element 22: Wherein the inner form is formed from a degradable material selected from the group consisting of an oil-degradable polymer, a degradable polymer, a dehydrated salt, and any combination thereof, the method further comprising degrading the inner form.

Element 23: Wherein the outer form is formed from a degradable material selected from the group consisting of an oil-degradable polymer; a degradable polymer; or a dehydrated salt, the method further comprising degrading the outer form.

Element 24: Wherein the inner form and the outer form are formed from a degradable material selected from the group consisting of an oil-degradable polymer; a degradable polymer; or a dehydrated salt, the method further comprising degrading the inner form and the outer form.

Element 25: Further comprising removing the outer form after curing the composite resinous material.

By way of non-limiting example, exemplary combinations applicable to A, B, C include: A with 1, 3, and 6; A with 9 and 10; B with 2, 5, and 11; B with 12 and 13; C with 8, 14, 17, and 18; C with 5, 7, and 20.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A housing assembly, comprising:
an outer form arranged about a base pipe, the base pipe including at least one flow port;
an inner form arranged about the base pipe and nested within the outer form, thereby defining a sealed compartment between the outer and inner forms; and
a composite resinous material disposable within the sealed compartment and curable to form a rigid housing arranged at or near the at least one flow port and in fluid communication therewith.

2. The housing assembly of claim 1, wherein the outer form is coupled to at least one end of a well screen.

3. The housing assembly of claim 2, wherein the inner form is coupled to at least one end of the well screen.

4. The housing assembly of claim 1, wherein the inner form defines at least one arched flow conduit.

5. The housing assembly of claim 1, wherein at least one flow control device is arranged at or near the at least one flow port.

6. The housing assembly of claim 5, wherein the at least one flow control device is an inflow control device or an autonomous inflow control device.

7. The housing assembly of claim 1, further comprising an injection port defined in the outer form and providing a location where the composite resinous material is able to be disposed within the sealed compartment.

8. The housing assembly of claim 1, wherein at least one of the inner and outer forms is formed from a material selected from the group consisting of a metal, a metal alloy, a metal carbide, zirconia, titania, alumina, a thermoset plastic, polystyrene, polyvinyl chloride, polytetrafluoroethylene, an aliphatic polyamide, plaster, an oil-degradable polymer, a degradable polymer, a dehydrated salt, and any combination thereof.

9. The housing assembly of claim 1, wherein the composite resinous material is selected from the group consisting of a two component epoxy based resin, a novolak resin, a polyepoxide resin, a phenol-aldehyde resin, a urea-aldehyde resin, a urethane resin, a phenolic resin, a furan resin, a furan/furfuryl alcohol resin, a phenolic/latex resin, a phenol formaldehyde resin, a silicon-based resin, a polyester resin, a polyester copolymer resin, a polyester hybrid resin, a polyurethane resin, a polyurethane copolymer resin, a polyurethane hybrid resin, an acrylate resin, a silicon-based resin, and any combination thereof.

10. The housing assembly of claim 1, wherein the composite resinous material further comprises an additive selected from the group consisting of a filler particle, an activator, a catalyst, a hardening agent, a bonding agent, an accelerator, a solvent, and any combination thereof.

11. The housing assembly of claim 1, wherein the inner form comprises an upper inner form and a lower inner form.

12. The housing assembly of claim 11, wherein at least one flow control device extends between the upper inner form and the lower inner form.

13. The housing assembly of claim 1, wherein the inner form comprises an upper inner form, a middle inner form, and a lower inner form.

14. The housing assembly of claim 1, wherein the outer form is removable after curing the composite resinous material.

15. A system, comprising:
a base pipe;
a housing assembly arranged about the base pipe, the base pipe including at least one flow port,
wherein the housing assembly includes an outer form arranged about the base pipe, and an inner form arranged about the base pipe and nested within the outer form, thereby defining a sealed compartment between the outer and inner forms; and
a composite resinous material disposable within the sealed compartment and curable to form a rigid housing arranged at or near the at least one flow port and in fluid communication therewith.

16. The system of claim 15, wherein the outer form is coupled to at least one end of a well screen.

17. The system of claim 16, wherein the inner form is coupled to at least one end of the well screen.

18. The system of claim 15, wherein the inner form defines at least one arched flow conduit.

19. The system of claim 15, wherein at least one flow control device is arranged at or near the at least one flow port.

20. The system of claim 19, wherein the at least one flow control device is an inflow control device or an autonomous inflow control device.

21. The system of claim 15, wherein the housing assembly further comprises an injection port defined in the outer form and providing a location where the composite resinous material is able to be disposed within the sealed compartment.

22. The system of claim 15, wherein at least one of the inner and outer forms is formed from a material selected from the group consisting of a metal, a metal alloy, a metal carbide, zirconia, titania, alumina, a thermoset plastic, polystyrene, polyvinyl chloride, polytetrafluoroethylene, an aliphatic polyamide, plaster, an oil-degradable polymer, a degradable polymer, a dehydrated salt, and any combination thereof.

23. The system of claim 15, wherein the composite resinous material is selected from the group consisting of a two component epoxy based resin, a novolak resin, a polyepoxide resin, a phenol-aldehyde resin, a urea-aldehyde resin, a urethane resin, a phenolic resin, a furan resin, a furan/furfuryl alcohol resin, a phenolic/latex resin, a phenol formaldehyde resin, a silicon-based resin, a polyester resin, a polyester copolymer resin, a polyester hybrid resin, a polyurethane resin, a polyurethane copolymer resin, a polyurethane hybrid resin, an acrylate resin, a silicon-based resin, and any combination thereof.

24. The system of claim 15, wherein the composite resinous material further comprises an additive selected from the group consisting of a filler particle, an activator, a catalyst, a hardening agent, a bonding agent, an accelerator, a solvent, and any combination thereof.

25. A method, comprising:
arranging a housing assembly about a base pipe, the base pipe including at least one flow port,
the housing assembly including an outer form arranged about the base pipe, and an inner form arranged about the base pipe and nested within the outer form, thereby defining a sealed compartment between the outer and inner forms;
pumping a composite resinous material into the sealed compartment; and
curing the composite resinous material to form a rigid housing arranged at or near the at least one flow port and in fluid communication therewith.

26. The method of claim 25, further comprising coupling the outer form to at least one end of a well screen.

27. The method of claim 26, further comprising coupling the inner form to at least one end of the well screen.

28. The method of claim 25, wherein arranging the housing assembly about the base pipe further comprises coupling the inner form to one end of a well screen.

29. The method of claim 25, further comprising drawing into the rigid housing and through the at least one flow port.

30. The method of claim 25, wherein arranging the housing assembly about the base pipe further comprises coupling the inner form at a first end and at a second end to a well screen.

31. The method of claim 30, further comprising drawing a fluid into the rigid housing through a portion of the well screen coupled to the inner form at the first end, wherein a first portion of the fluid is discharged through the at least one flow port and a second portion of the fluid is discharged through a portion of the well screen coupled to the inner form at the second end.

32. The method of claim 30, further comprising drawing a fluid into the rigid housing through a portion of the well screen coupled to the inner form at the second end, wherein a first portion of the fluid is discharged through the at least one flow port and a second portion of the fluid is discharged through a portion of the well screen coupled to the inner form at the first end.

33. The method of claim 25, further comprising arranging at least one flow control device at or near the at least one flow port.

34. The method of claim 25, wherein the inner form is formed from a degradable material selected from the group consisting of an oil-degradable polymer, a degradable polymer, a dehydrated salt, and any combination thereof, the method further comprising degrading the inner form.

35. The method of claim 25, wherein the outer form is formed from a degradable material selected from the group consisting of an oil-degradable polymer; a degradable polymer; or a dehydrated salt, the method further comprising degrading the outer form.

36. The method of claim 25, wherein the inner form and the outer form are formed from a degradable material selected from the group consisting of an oil-degradable polymer; a degradable polymer; or a dehydrated salt, the method further comprising degrading the inner form and the outer form.

37. The method of claim 25, further comprising removing the outer form after curing the composite resinous material.
